(19) United States
(12) Patent Application Publication
(10) Pub. No.: US 2026/0181572 A1
(43) Pub. Date: Jun. 25, 2026

(54) Communications System with Registration Collision Mitigation

(71) Applicant: Apple Inc., Cupertino, CA (US)

(72) Inventors: Shahram Talakoub, San Jose, CA (US); Sebastian B Seeber, San Carlos, CA (US); Saurabh Deo, Cupertino, CA (US); Venkateswara Rao Manepalli, San Jose, CA (US); Lohit Sarna, San Diego, CA (US); Sudeep Bhattarai, Fremont, CA (US)

(21) Appl. No.: 18/988,334

(22) Filed: Dec. 19, 2024

(51) Int. Cl. H04W 60/00; H04L 69/22; H04W 84/06

(52) U.S. Cl. CPC H04W 60/00; H04L 69/22; H04W 84/06

(57) ABSTRACT

A communications system may include user equipment (UE) devices that communicate with a network via a constellation of satellites. A UE may transmit a registration message to the network via a satellite, including information usable by the network to identify a first temporary user identifier (TUID) of the UE. The network may transmit a registration acknowledgment (ACK) that includes include the first TUID. In response to receiving the registration ACK, the UE may convey wireless data with the network under an assumption that the UE is in a registered/connected communications session with the network. The UE may perform these communications based on a second TUID that is different than the first TUID. If the network is unable to perform a successful integrity check on reverse link messages from the UE, the network may transmit a TUID flash message including the second TUID on all signal beams of the satellite.

### FIELD

This relates generally to wireless communications, including wireless communications by user equipment devices.

### BACKGROUND

Communications systems are used to convey data between terminals such as user equipment (UE) devices. In performing wireless communications, a UE device wirelessly transmits data to a wireless network. The wireless network forwards the data to an intended recipient device.

In practice, some wireless networks exhibit limited speed and/or bandwidth in communicating with UE devices. These constraints become more significant as the number of UE devices served by the network increase. If care is not taken, a UE device will need to wait an excessive amount of time to successfully transmit data over such a wireless network, which can be detrimental to user experience.

### SUMMARY

A communications system may include user equipment (UE) devices that communicate with a core network via a constellation of communications satellites. A UE device may transmit a registration message to the core network via a signal beam of a satellite in the constellation. The registration message may include information that is usable by the core network to identify a first temporary user identifier (TUID) associated with the UE device. The core network may transmit a registration acknowledgment (ACK) to the registration message in a broadcast message. The registration ACK may include the first TUID.

In response to receiving the registration ACK including the first TUID, the UE device may convey wireless data with the core network under an assumption that the UE device is in a registered/connected communications session with the core network. The UE device may perform these communications based on a second TUID that is different than the first TUID. The first and second TUIDs may, for example, be formed from respective series of bits in different bit positions of a cryptographic hash value. The UE device may transmit reverse link messages that include the second TUID, may receive ACKs to the reverse link messages that include the second TUID, may receive unicast forward link messages that include the TUID, and/or may transmit ACKs to the forward link messages that include the second TUID. If the core network is unable to perform a successful integrity check on reverse link messages from the UE device, the core network may transmit a TUID flash message on all signal beams of the satellite. The TUID flash message may include the second TUID. These techniques may effectively mitigate situations where multiple UE devices in the same signal beam of the same satellite attempt to register with the core network using the same TUID during the same system cycle. This may minimize communication delays and may optimize user experience with the UE devices.

An aspect of the disclosure provides a method of operating a user equipment (UE) device to communicate with a core network via a constellation of satellites. The method can include transmitting, to the core network via a satellite in the constellation, a registration message that includes information usable by the core network to identify a first temporary user identifier (TUID) associated with the UE device. The method can include receiving, from the core network via the satellite, a registration acknowledgment (ACK) that includes the first TUID. The method can include conveying, during a communications session associated with the registration message, wireless data with the core network based on a second TUID that is different than the first TUID.

An aspect of the disclosure provides a method of operating a core network to communicate via a constellation of satellites. The method can include receiving, from a user equipment (UE) device via a satellite in the constellation, a registration request. The method can include generating, using one or more processors, a first temporary user identifier (TUID) based on information in the registration request. The method can include transmitting, via the satellite, a registration acknowledgment (ACK) that includes the first TUID. The method can include conveying, during a communications session associated with the registration message, wireless data with the UE device using a second TUID that is different than the first TUID.

An aspect of the disclosure provides a method of operating a core network to communicate via a constellation of satellites. The method can include receiving, from a user equipment (UE) device via a signal beam in a plurality of signal beams formed by a satellite in the constellation, a reverse link message that includes information associated with a temporary user identifier (TUID) of the UE device. The method can include performing, using one or more processors, an integrity check on the reverse link message. The method can include transmitting, responsive to a failure of the integrity check, a flash message over the plurality of signal beams formed by the satellite during a system cycle of the satellite, wherein the flash message comprises the TUID.

### BRIEF DESCRIPTION OF THE DRAWINGS

FIG. 1 is a diagram of an illustrative communications system including user equipment devices that communicate with a core network in accordance with some embodiments.

FIG. 2 is a schematic diagram of an illustrative user equipment device in accordance with some embodiments.

FIG. 3 is a schematic diagram of an illustrative communications satellite in accordance with some embodiments.

FIG. 4 is a schematic diagram of an illustrative core network in accordance with some embodiments.

FIG. 5 is a flow chart of illustrative operations involved in performing wireless communications between a user equipment device and a core network in accordance with some embodiments.

FIG. 6 is a diagram showing how an illustrative user equipment device or core network may generate temporary user identifiers in accordance with some embodiments.

FIGS. 7 and 8 are flow charts of illustrative operations involved in performing wireless communications between a user equipment device and a core network based on multiple different temporary user identifiers for mitigating the risk of a mistaken registration condition in accordance with some embodiments.

FIG. 9 is a diagram of an illustrative broadcast message that may be transmitted by a core network in accordance with some embodiments.

FIG. 10 is a diagram of an illustrative temporary user identifier flash message that may be transmitted by a core network in accordance with some embodiments.

FIG. 11 is a diagram of an illustrative reverse link message that may be transmitted by a user equipment device in accordance with some embodiments.

### DETAILED DESCRIPTION

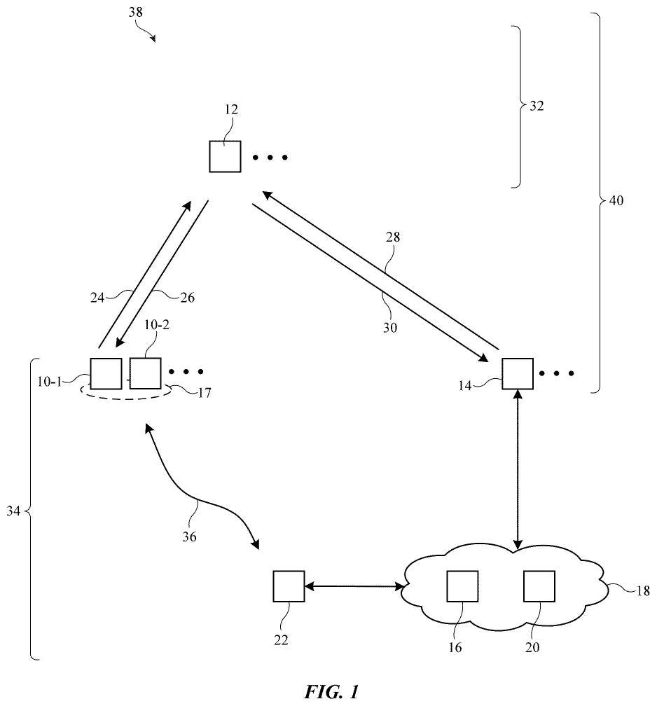

FIG. 1 is a diagram of an illustrative communications system 38. Communications system 38 (sometimes referred to herein as communications network 38, network 38, system 38, satellite communications system 38, or satellite communications network 38) may include a ground-based (terrestrial) gateway system that includes one or more gateways 14 and may include one or more user equipment (UE) devices 10 such as at least a first UE device 10-1 and a second UE device 10-2. Gateways 14 and UE devices 10 may form a part of a terrestrial network 34 on Earth. Terrestrial network 34 may include terrestrial-based wireless communications equipment 22 and network portion 18. Terrestrial-based wireless communications equipment 22 may include, for example, one or more wireless base stations (e.g., for implementing a cellular telephone network), wireless access points (e.g., for implementing a wireless local area network (WLAN)), and/or other UE devices (e.g., for implementing a device-to-device (D2D) network, a wireless personal area network (WPAN), etc.).

Communications system 38 may include a constellation 32 of one or more communications satellites 12 (sometimes referred to herein simply as satellites 12). UE devices 10, gateways 14, and constellation 32 may form a part of non-terrestrial network (NTN) 40, which conveys signals between UE devices 10 and gateways 14 via constellation 32. Constellation 32 may sometimes be referred to herein as satellite constellation 32. Communications satellites 12 are located in space (e.g., in orbit around Earth). Communications system 38 may include any desired number of gateways 14, any desired number of communications satellites, and any desired number of UE devices 10. Only a single gateway 14, three communications satellites, and two UE devices 10-1 and 10-2 are illustrated in FIG. 1 for the sake of clarity. Each gateway 14 in communications system 38 may be located at a different respective geographic location on Earth (e.g., across different regions, cities, counties, prefectures, districts, municipalities, land masses, areas, localities, states, provinces, countries, continents, etc.).

Network portion 18 may be communicatively coupled to terrestrial-based wireless communications equipment 22 and each of the gateways 14 in communications system 38. Gateway (GW) 14 may include a satellite network ground station and may therefore sometimes also be referred to as ground station (GS) 14 or satellite network ground station 14. Each gateway 14 may include one or more antennas (e.g., electronically and/or mechanically adjustable antennas), modems, transceivers, amplifiers, beam forming circuitry, control circuitry (e.g., one or more processors, storage circuitry, etc.) and other components that are used to convey communications data. The components of each gateway 14 may, for example, be disposed at a respective geographic location (e.g., within the same computer, server, data center, building, etc.). Gateways 14 may convey communications data between terrestrial network 34 and UE devices 10 via satellite constellation 32.

Network portion 18 may include any desired number of network nodes, terminals, and/or end hosts that are communicably coupled together using communications paths that include wired and/or wireless links. The wired links may include cables (e.g., ethernet cables, optical fibers or other optical cables that convey signals using light, telephone cables, etc.). Network portion 18 may include one or more relay networks, mesh networks, local area networks (LANs), wireless local area networks (WLANs), ring networks (e.g., optical rings), cloud networks, virtual/logical networks, the Internet, combinations of these, and/or any other desired network nodes coupled together using any desired network topologies (e.g., on Earth). The network nodes, terminals, and/or end hosts may include network switches, network routers, optical add-drop multiplexers, other multiplexers, repeaters, modems, servers, network cards, wireless access points, wireless base stations, UE devices such as UE devices 10, and/or any other desired network components. The network nodes in network portion 18 may include physical components such as electronic devices, servers, computers, user equipment, etc., and/or may include virtual components that are logically defined in software and that are distributed across (over) two or more underlying physical devices (e.g., in a cloud network configuration).

Network portion 18 may include one or more satellite network operations centers such as network operations center (NOC) 16. NOC 16 may control the operation of gateways 14 in communicating with satellite constellation 32. NOC 16 may also control the operation of the satellites in satellite constellation 32. For example, NOC 16 may convey control commands via gateways 14 that control positioning operations (e.g., orbit adjustments), sensing operations (e.g., thermal information gathered using one or more thermal sensors), and/or any other desired operations performed in space by satellites 12. NOC 16, gateways 14, and satellite constellation 32 may be operated or managed by a corresponding satellite constellation operator.

Communications system 38 may also include a satellite communications (satcom) network service provider (e.g., a satcom network carrier or operator) for controlling wireless communications between UE devices 10 and terrestrial network 34 via satellite constellation 32. The satcom network service provider may be a different entity than the satellite constellation operator that controls/operates NOC 16, gateways 14, and satellite constellation 32, or may be the same entity as the satellite constellation operator. Terrestrial-based wireless communications equipment 22 in terrestrial network 34 may be operated by one or more terrestrial network carriers or service providers. The terrestrial network carriers or service providers may be different entities than the satcom network service provider or, if desired, may be the same entity as the satcom network service provider.

One or more gateways 14 may control the operations of satellite constellation 32 over corresponding radio-frequency communications links. Satellite constellation 32 may include any desired number of satellites (e.g., two satellites, four satellites, ten satellites, dozens of satellites, hundreds of satellites, thousands of satellites, etc.), three of which are shown in FIG. 1. If desired, two or more of the satellites in satellite constellation 32 may convey radio-frequency signals between each other using satellite-to-satellite (e.g., relay) links.

Constellation 32 may include a set of non-geostationary orbit (NGSO) satellites (e.g., satellites in non-geostationary orbits) and, if desired, may include a set of geostationary orbit (GSO) satellites (e.g., satellites in geostationary/geosynchronous orbits, sometimes referred to as geosynchronous satellites or GEO satellites). NGSO satellites may move relative to the surface of Earth over time (e.g., at velocities V relative to the surface of Earth). GSO satellites do not move relative to the surface of Earth (e.g., may orbit around Earth at a velocity that matches the rotation of Earth given the altitude of the satellites).

GSO satellites 12 may orbit Earth at orbital altitudes of greater than around 30,000 km. NGSO satellites 12 may include low earth orbit (LEO) satellites at orbital altitudes of less than around 8,000 km (e.g., satellites in low earth orbits, inclined low earth orbits, low earth circular orbits, etc.), medium earth orbit (MEO) satellites at orbital altitudes between around 8,000 km and 30,000 km (e.g., satellite in medium earth orbits), sun synchronous satellites (e.g., satellites in sun synchronous orbits), satellites in tundra orbits, satellites in Molniya orbits, satellites in polar orbits, and/or satellites in any other desired non-geosynchronous orbits around Earth. If desired, satellites 12 may include multiple sets of satellites each in a different type of orbit and/or each at a different orbital altitude. In general, constellation 32 may include satellites in any desired combination of orbits or orbit types. GSO satellites may be omitted from constellation 32 if desired.

The satellites in constellation 32 may communicate with one or more UE devices 10 on Earth using one or more radio-frequency communications links (e.g., satellite-to-user equipment links). Satellites 12 may also communicate with gateways 14 on Earth using radio-frequency communications links (e.g., satellite-to-gateway links). Radio-frequency signals may be conveyed between UE devices 10 and satellites 12 and between satellites 12 and gateways 14 in IEEE bands such as the IEEE C band (4-8 GHz), S band (2-4 GHz), L band (1-2 GHz), X band (8-12 GHz), W band (75-110 GHz), V band (40-75 GHz), K band (18-27 GHz), Kₐ band (26.5-40 GHz), Kᵤ band (12-18 GHz), and/or any other desired satellite communications bands. If desired, different bands may be used for the satellite-to-user equipment links than for the satellite-to-gateway links.

Communications may be performed between gateways 14 and UE devices 10 in a forward (FWD) link direction and/or in a reverse (REV or RWD) link direction. In the forward link direction (sometimes referred to simply as the forward link), wireless data is conveyed from gateways 14 to UE device(s) 10 via satellite constellation 32. Wireless data conveyed over the forward link is sometimes referred to herein as forward link data. Forward link data may be organized into a set, series, or stream of forward link datagrams (e.g., having header fields that contain header information, payload fields that contain a forward link data payload, etc.). A gateway 14 may, for example, transmit forward link data to one of the satellites 12 in satellite constellation 32 (e.g., where forward link datagrams are modulated onto one or more carriers of radio-frequency signals 28). Satellite 12 may transmit (e.g., relay, in a bent-pipe configuration) the forward link data received from gateway 14 to UE device(s) 10 (e.g., using radio-frequency signals 26). Radio-frequency signals 28 are conveyed in an uplink direction from gateway 14 to satellite 12 and are therefore sometimes also referred to herein as uplink (UL) signals 28, forward link UL signals 28, or forward link signals 28. Radio-frequency signals 26 are conveyed in a downlink direction from satellite 12 to UE device(s) 10 and are therefore sometimes also referred to herein as downlink (DL) signals 26, forward link DL signals 26, or forward link signals 26.

In the reverse link direction (sometimes referred to simply as the reverse link), wireless data is conveyed from UE device(s) 10 to gateways 14 via satellite constellation 32. Wireless data conveyed over the reverse link is sometimes referred to herein as reverse link data. Reverse link data may be organized into a set, series, or stream of reverse link datagrams (e.g., having header fields that contain header information, payload fields that contain a reverse link data payload, etc.). One of UE devices 10 may, for example, transmit reverse link data to one of the satellites 12 in constellation 32 (e.g., where reverse link datagrams are modulated onto one or more carriers of radio-frequency signals 24). Satellite 12 may transmit (e.g., relay, in a bent-pipe configuration) the reverse link data received from UE device 10 to a corresponding gateway 14 using radio-frequency signals 30. Radio-frequency signals 24 are conveyed in an uplink direction from UE device 10 to satellite 12 and are therefore sometimes also referred to herein as uplink (UL) signals 24, reverse link UL signals 24, or reverse link signals 24. Radio-frequency signals 30 are conveyed in a downlink direction from satellite 12 to gateway 14 and are therefore sometimes also referred to herein as downlink (DL) signals 30, reverse link DL signals 30, or reverse link signals 30. Gateway 14 may forward wireless data between UE device(s) 10 and network portion 18. Network portion 18 may forward the wireless data to any desired network nodes or terminals of terrestrial network 34.

If desired, UE devices 10 may also convey radio-frequency signals with terrestrial-based wireless communications equipment 22 over terrestrial network wireless communication links 36 when available. UE devices 10 may sometimes be referred to herein as being “online” or “on-grid” when the UE devices are within range of terrestrial-based wireless communications equipment 22 and when terrestrial-based wireless communications equipment 22 provides access (e.g., communications resources) to network portion 18 for the UE devices. When the UE devices are online, the UE devices may communicate with other network nodes or terminals in network portion 18 via terrestrial network wireless communications links 36. Conversely, UE devices 10 may sometimes be referred to herein as being “offline” or “off-grid” when the UE devices are out of range of terrestrial-based wireless communications equipment 22 or when terrestrial-based wireless communications equipment 22 does not provide access to network portion 18 for the UE devices (e.g., when terrestrial-based wireless communications equipment 22 is disabled due to a power outage, natural disaster, traffic surge, or emergency, when terrestrial-based wireless communications equipment 22 denies access to network portion 18 for the UE devices, when terrestrial-based wireless communications equipment 22 is overloaded with traffic, etc.).

If desired, UE devices 10 may include separate antennas for handling communications over the satellite-to-user equipment link and one or more terrestrial network wireless communication links 36 or UE devices 10 may include a single antenna that handles both the satellite-to-user equipment link and the terrestrial network wireless communications links. The terrestrial network wireless communications links may be, for example, cellular telephone links (e.g., links maintained using a cellular telephone communications protocol such as a 4G Long Term Evolution (LTE) protocol, a 3G protocol, a 3GPP Fifth Generation (5G) New Radio (NR) protocol, etc.), wireless local area network links (e.g., Wi-Fi® links), wireless personal area network links (e.g., Bluetooth links), D2D links, etc.

The wireless data conveyed in DL signals 26 is sometimes also referred to herein as DL data, forward link DL data, or forward link data. UL signals 28 may also convey the forward link data (e.g., forward link data that is routed by satellite 12 to UE device(s) 10 in DL signals 26). The wireless data conveyed in UL signals 24 is sometimes also referred to herein as UL data, reverse link UL data, or reverse link data. The reverse link data may be generated and transmitted by UE device(s) 10. DL signals 30 may also convey the reverse link data. Forward link data may be generated by any desired network nodes or terminals of terrestrial network 34. Forward link data and the reverse link data may include text data such as email messages, text messages, web browser data, an emergency or SOS message, a location message identifying the location of UE device(s) 10, or other text-based data, audio data such as voice data (e.g., for a bi-directional satellite voice call) or other audio data (e.g., streaming satellite radio data), video data (e.g., for a bi-directional satellite video call or to stream video data transmitted by gateway 14 at UE device(s) 10), cloud network synchronization data, data generated or used by software applications running on UE device(s) 10 (e.g., application data), data for use in a distributed processing network, and/or any other desired data. UE devices 10 may only receive forward link data, may only transmit reverse link data, or may both transmit reverse link data and receive forward link data.

Each satellite 12 may communicate with the UE devices 10 located within a corresponding coverage area at any given time. The coverage area may, for example, correspond to an area or region on earth that overlaps the footprint of a signal beam 17 of satellite 12. Satellite 12 may communicate over multiple different signal beams oriented in different directions (e.g., overlapping different regions on Earth). If desired, satellite 12 may communicate over multiple different signal beams at once and/or may switch between communicating using different signal beams over time (e.g., in a time-division-duplexing or beam hopping scheme). In the example of FIG. 1, at least UE devices 10-1 and 10-2 overlap signal beam 17 of satellite 12. Satellite 12 may use signal beam 17 to communicate with both UE devices 10-1 and 10-2. The downlink signals 26 routed by satellite 12 may include broadcast messages (e.g., for receipt by all UE devices overlapping signal beam 17) and/or unicast messages (e.g., addressed to a single particular UE device overlapping signal beam 17).

The satcom network service provider for communications system 38 may operate, control, and/or manage a satcom control network such as core network (CN) 20 in network portion 18. CN 20 may sometimes also be referred to herein as satcom network region 20, CN region 20, satcom controller 20, satcom network 20, or satcom service provider equipment 20. CN 20 may be implemented on one or more network nodes and/or terminals of network portion 18 (e.g., one or more servers or other end hosts). In some implementations, CN 20 may be formed from a cloud computing network distributed over multiple underlying physical network nodes and/or terminals distributed across one or more geographic regions. CN 20 may therefore sometimes also be referred to herein as a CN cloud region or satcom network cloud region.

CN 20 may control and coordinate wireless communications between terminals (e.g., end hosts) of terrestrial network 34 and UE devices 10 via satellite constellation 32. For example, gateways 14 may receive reverse link data from UE devices 10 via satellite constellation 32 and may route the reverse link data to CN 20. CN 20 may perform any desired processing operations on the reverse link data. For example, CN 20 may identify destinations for the reverse link data and may forward the reverse link data to the identified destinations. CN 20 may also receive forward link data for transmission to UE devices 10 from one or more terminals or end hosts of terrestrial network 34 (e.g., network portion 18). CN 20 may process the forward link data to schedule the forward link data for transmission to UE devices 10 via satellite constellation 32. CN 20 may schedule the forward link data for transmission to UE devices 10 by generating forward link traffic grants for each of the UE devices that are to receive forward link data. CN 20 may provide the forward link data and the forward link traffic grants to gateways 14. Gateways 14 may transmit the forward link data to UE devices 10 via satellite constellation 32 according to the forward link traffic grants (e.g., according to a forward link communications schedule that implements the forward link traffic grants). CN 20 may include, be coupled to, and/or be associated with one or more content delivery networks (CDNs) that provide content for delivery to UE devices 10.

The time resources used for communications between CN 20 and a UE device 10 may be divided into a series of repeating system cycles over time (sometimes also referred to as system frames). Each system cycle may include a respective downlink (forward link) cycle and/or a respective uplink (reverse link) cycle. During each forward link cycle, CN 20 transmits a broadcast message to each of the UE devices 10 served by a given satellite 12 via that satellite 12. CN 20 may, for example, transmit a broadcast message to satellite 12 via gateway 14 and satellite 12 may transmit/forward the broadcast message over its signal beam 17. The broadcast message may have a destination address field set to a broadcast address. CN 20 may also transmit one or more unicast messages (e.g., containing forward link data) to one or more of the UE devices 10 during the forward link cycle (e.g., during a portion of the forward link cycle not occupied by the broadcast message). During a reverse link cycle, a UE device 10 may transmit a reverse link message (e.g., containing reverse link data) to CN 20 via its serving satellite 12. The reverse link message may include, for example, one or two reverse link datagrams. The reverse link cycle may have the same duration as the forward link cycle or may have a different duration. Each system cycle may have a duration (period) of between 2 seconds and 3 seconds (e.g., 2.56 seconds), between 1 second and 10 seconds, between 1 second and 5 seconds, greater than 1 second, greater than 2 seconds, less than 5 seconds, less than 10 seconds, or other durations.

The example of FIG. 1 in which communications system 38 includes NTN 40 is illustrative and non-limiting. In general, constellation 32 and gateways 14, as described in any of the examples herein, may be replaced with any desired type of wireless network having any desired network nodes (e.g., a terrestrial wireless network). In these implementations, satellites 12 as described herein may be replaced with any desired serving nodes of the network, where the serving nodes route communications between CN 20 and UE devices 10 (e.g., the serving nodes may include satellites 12, wireless base stations, access points, other UE devices, unmanned aerial vehicles, etc.). In general, signal beam 17 may represent the coverage area of a corresponding serving node (e.g., satellite 12) that routes wireless data between UE devices 10 overlapping the coverage area and CN 20. Examples in which the network includes constellation 32 and the serving nodes include satellites 12 are described herein for the sake of illustration.

UE device 10 may be a computing device such as a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses or other equipment worn on a user's head, or other wearable or miniature device, a television, a computer display that does not contain an embedded computer, a gaming device, a navigation device, an embedded system such as a system in which electronic equipment with a display is mounted in a kiosk or automobile, a wireless internet-connected voice-controlled speaker, a home entertainment device, a remote control device, a gaming controller, a peripheral user input device, a wireless base station or access point, equipment that implements the functionality of two or more of these devices, or other electronic equipment.

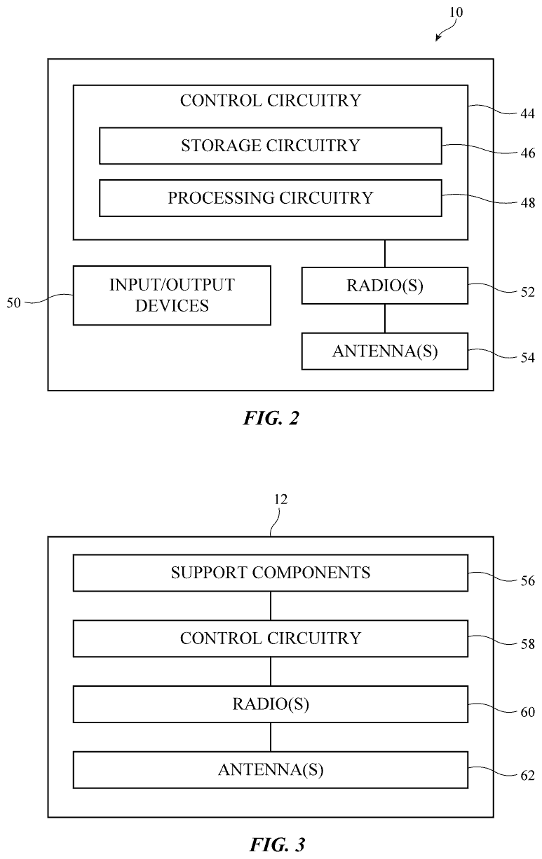

As shown in FIG. 2, UE device 10 (e.g., UE device 10-1 or UE device 10-2 of FIG. 1) may include components located on or within an electronic device housing such as housing 42. Housing 42, which may sometimes be referred to as a case, may be formed of plastic, glass, ceramics, fiber composites, metal (e.g., stainless steel, aluminum, metal alloys, etc.), other suitable materials, or a combination of these materials. In some situations, parts or all of housing 42 may be formed from dielectric or other low-conductivity material (e.g., glass, ceramic, plastic, sapphire, etc.). In other situations, housing 42 or at least some of the structures that make up housing 42 may be formed from metal elements.

UE device 10 may include control circuitry 44. Control circuitry 44 may include storage such as storage circuitry 46. Storage circuitry 46 may include hard disk drive storage, nonvolatile memory (e.g., flash memory or other electrically-programmable-read-only memory configured to form a solid-state drive), volatile memory (e.g., static or dynamic random-access-memory), etc. Storage circuitry 46 may include storage that is integrated within UE device 10 and/or removable storage media.

Control circuitry 44 may include processing circuitry such as processing circuitry 48. Processing circuitry 48 may be used to control the operation of UE device 10. Processing circuitry 48 may include on one or more processors (e.g., microprocessors, microcontrollers, digital signal processors, host processors, baseband processor integrated circuits, application specific integrated circuits, central processing units (CPUs), graphics processing units (GPUs), etc.). Control circuitry 44 may be configured to perform operations in device 10 using hardware (e.g., dedicated hardware or circuitry), firmware, and/or software. Software code for performing operations on UE device 10 may be stored on storage circuitry 46 (e.g., storage circuitry 46 may include non-transitory (tangible) computer readable storage media that stores the software code). The software code may sometimes be referred to as program instructions, software, data, instructions, or code. Software code stored on storage circuitry 46 may be executed by processing circuitry 48.

Control circuitry 44 may be used to run software on UE device 10 such as satellite navigation applications, internet browsing applications, voice-over-internet-protocol (VOIP) telephone call applications, email applications, media playback applications, operating system functions, etc. To support interactions with external equipment, control circuitry 44 may be used in implementing communications protocols. Communications protocols that may be implemented using control circuitry 44 include internet protocols, wireless local area network (WLAN) protocols (e.g., IEEE 802.11 protocols—sometimes referred to as Wi-Fi®), protocols for other short-range wireless communications links such as the Bluetooth® protocol or other wireless personal area network (WPAN) protocols, IEEE 802.11ad protocols (e.g., ultra-wideband protocols), cellular telephone protocols (e.g., 3G protocols, 4G (LTE) protocols, 3GPP Fifth Generation (5G) New Radio (NR) protocols, Sixth Generation (6G) protocols, sub-THz protocols, THz protocols, etc.), antenna diversity protocols, satellite navigation system protocols (e.g., global positioning system (GPS) protocols, global navigation satellite system (GLONASS) protocols, etc.), antenna-based spatial ranging protocols (e.g., radio detection and ranging (RADAR) protocols or other desired range detection protocols for signals conveyed at millimeter and centimeter wave frequencies), satellite communications protocols, and/or any other desired communications protocols. Each communications protocol may be associated with a corresponding radio access technology (RAT) that specifies the physical connection methodology used in implementing the protocol.

UE device 10 may store satellite information associated with one or more of the satellites 12 in satellite constellation 32 on storage circuitry 46. The satellite information, sometimes referred to herein as ephemeris data, ephemeris information, or simply as satellite ephemeris, may include a satellite almanac or another data structure identifying the orbital parameters/position (e.g., orbit information, elevation information, altitude information, inclination information, eccentricity information, orbital period information, trajectory information, right ascension information, declination information, ground track information, etc.) and/or the velocity of satellites 12 (e.g., relative to the surface of Earth). This information may include one or more two-line elements (TLEs), for example. A TLE may identify or include information about the orbital motion of one or more of the satellites 12 in satellite constellation 32 (e.g., satellite epoch, first and/or second derivatives of motion, drag terms, etc.). The TLE may be in the format of a text file having two lines or columns that include the set of elements forming the TLE, for example. Control circuitry 44 may use the ephemeris to calculate, predict, or identify the location of satellites 12 at a given point in time.

UE device 10 may also include wireless circuitry to support wireless communications. The wireless circuitry may include one or more antennas 54 and one or more radios 52. Each radio 52 may include circuitry that operates on signals at baseband frequencies (e.g., baseband processing circuitry, one or more baseband processors, etc.), signal generator circuitry, modulation/demodulation circuitry (e.g., one or more modems), radio-frequency transceiver circuitry (e.g., radio-frequency transmitter circuitry, radio-frequency receiver circuitry, mixer circuitry for downconverting radio-frequency signals to baseband frequencies or intermediate frequencies between radio and baseband frequencies and/or for upconverting signals at baseband or intermediate frequencies to radio-frequencies, etc.), amplifier circuitry (e.g., one or more power amplifiers and/or one or more low-noise amplifiers (LNAs)), analog-to-digital converter (ADC) circuitry, digital-to-analog converter (DAC) circuitry, control paths, power supply paths, signal paths (e.g., radio-frequency transmission lines, intermediate frequency transmission lines, baseband signal lines, etc.), switching circuitry, filter circuitry, and/or any other circuitry for transmitting and/or receiving radio-frequency signals using antenna(s) 54. The components of each radio 52 may be mounted onto a respective substrate or integrated into a respective integrated circuit, chip, package, or system-on-chip (SOC). If desired, the components of multiple radios 52 may share a single substrate, integrated circuit, chip, package, or SOC.

Antenna(s) 54 may be formed using any desired antenna structures. For example, antenna(s) 54 may include antennas with resonating elements that are formed from loop antenna structures, patch antenna structures, inverted-F antenna structures, slot antenna structures, planar inverted-F antenna structures, helical antenna structures, monopole antennas, dipoles, hybrids of these designs, etc. If desired, one or more antennas 54 may include antenna resonating elements formed from conductive portions of housing 42 (e.g., peripheral conductive housing structures extending around a periphery of a display on UE device 10). Filter circuitry, switching circuitry, impedance matching circuitry, and/or other antenna tuning components may be adjusted to adjust the frequency response and wireless performance of antenna(s) 54 over time. If desired, multiple antennas 54 may be implemented as a phased array antenna (e.g., where each antenna forms a radiator or antenna element of the phased array antenna, which is sometimes also referred to as a phased antenna array). In these scenarios, the phased array antenna may convey radio-frequency signals within a signal beam. The phases and/or magnitudes of each radiator in the phased array antenna may be adjusted so the radio-frequency signals for each radiator constructively and destructively interfere to steer or orient the signal beam in a particular pointing direction (e.g., a direction of peak signal gain). The signal beam may be adjusted or steered over time.

Transceiver circuitry in radios 52 may convey radio-frequency signals using one or more antennas 54 (e.g., antenna(s) 54 may convey the radio-frequency signals for the transceiver circuitry). The term “convey radio-frequency signals” as used herein means the transmission and/or reception of the radio-frequency signals (e.g., for performing unidirectional and/or bidirectional wireless communications with external wireless communications equipment). Antenna(s) 54 may transmit the radio-frequency signals by radiating the radio-frequency signals into free space (or to free space through intervening device structures such as a dielectric cover layer). Antenna(s) 54 may additionally or alternatively receive the radio-frequency signals from free space (e.g., through intervening devices structures such as a dielectric cover layer). The transmission and reception of radio-frequency signals by antenna(s) 54 each involve the excitation or resonance of antenna currents on an antenna resonating element in the antenna by the radio-frequency signals within the frequency band(s) of operation of the antenna.

Each radio 52 may be coupled to one or more antennas 54 over one or more radio-frequency transmission lines. The radio-frequency transmission lines may include coaxial cables, microstrip transmission lines, stripline transmission lines, edge-coupled microstrip transmission lines, edge-coupled stripline transmission lines, transmission lines formed from combinations of transmission lines of these types, etc. The radio-frequency transmission lines may be integrated into rigid and/or flexible printed circuit boards if desired. One or more of the radio-frequency lines may be shared between radios 52 if desired. Radio-frequency front end (RFFE) modules may be interposed on one or more of the radio-frequency transmission lines. The radio-frequency front end modules may include substrates, integrated circuits, chips, or packages that are separate from radios 52 and may include filter circuitry, switching circuitry, amplifier circuitry, impedance matching circuitry, radio-frequency coupler circuitry, and/or any other desired radio-frequency circuitry for operating on the radio-frequency signals conveyed over the radio-frequency transmission lines.

Radios 52 may use antenna(s) 54 to transmit and/or receive radio-frequency signals within different frequency bands at radio frequencies (sometimes referred to herein as communications bands or simply as a “bands”). The frequency bands handled by radios 52 may include satellite communications bands (e.g., the C band, S band, L band, X band, W band, V band, K band, Kₐ band, Kᵤ band, etc.), wireless local area network (WLAN) frequency bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), and/or other Wi-Fi® bands (e.g., from 1875-5160 MHz), wireless personal area network (WPAN) frequency bands such as the 2.4 GHz Bluetooth® band or other WPAN communications bands, cellular telephone frequency bands (e.g., bands from about 600 MHz to about 5 GHz, 3G bands, 4G LTE bands, 5G New Radio Frequency Range 1 (FR1) bands below 10 GHz, 5G New Radio Frequency Range 2 (FR2) bands between 20 and 60 GHz, 6G bands such as sub-THz bands between around 100 GHz and around 10 THz, etc.), other centimeter or millimeter wave frequency bands between 10-300 GHz, near-field communications (NFC) frequency bands (e.g., at 13.56 MHz), satellite navigation frequency bands (e.g., a GPS band from 1565 to 1610 MHz, a Global Navigation Satellite System (GLONASS) band, a BeiDou Navigation Satellite System (BDS) band, etc.), ultra-wideband (UWB) frequency bands that operate under the IEEE 802.15.4 protocol and/or other ultra-wideband communications protocols, communications bands under the family of 3GPP wireless communications standards, communications bands under the IEEE 802.XX family of standards, and/or any other desired frequency bands of interest.

Although control circuitry 44 is shown separately from radios 52 in the example of FIG. 2 for the sake of clarity, radios 52 may include processing circuitry that forms a part of processing circuitry 48 and/or storage circuitry that forms a part of storage circuitry 46 of control circuitry 44 (e.g., portions of control circuitry 44 may be implemented on radios 52). As an example, control circuitry 44 may include baseband circuitry or other control components that form a part of radios 52. The baseband circuitry may, for example, access a communication protocol stack on control circuitry 44 (e.g., storage circuitry 46) to: perform user plane functions at a PHY layer, MAC layer, RLC layer, PDCP layer, SDAP layer, and/or PDU layer, and/or to perform control plane functions at the PHY layer, MAC layer, RLC layer, PDCP layer, RRC, layer, and/or non-access stratum layer.

UE device 10 may include input-output devices 50. Input-output devices 50 may be used to allow data to be supplied to UE device 10 and to allow data to be provided from UE device 10 to external devices. Input-output devices 50 may include user interface devices, data port devices, and other input-output components. For example, input-output devices 50 may include touch sensors, displays (e.g., touch-sensitive and/or force-sensitive displays), light-emitting components such as displays without touch sensor capabilities, buttons (mechanical, capacitive, optical, etc.), scrolling wheels, touch pads, key pads, keyboards, microphones, cameras, buttons, speakers, status indicators, audio jacks and other audio port components, digital data port devices, motion sensors (accelerometers, orientation sensors, inertial measurement units, gyroscopes, and/or compasses that detect motion), capacitance sensors, proximity sensors, magnetic sensors, force sensors (e.g., force sensors coupled to a display to detect pressure applied to the display), temperature sensors, etc. In some configurations, keyboards, headphones, displays, pointing devices such as trackpads, mice, and joysticks, and other input-output devices may be coupled to device 10 using wired or wireless connections (e.g., some of input-output devices 50 may be peripherals that are coupled to a main processing unit or other portion of device 10 via a wired or wireless link). UE device 10 may be owned and/or operated by an end user.

A gateway 14 (FIG. 1) may include one or more radios that include one or more components similar to radio(s) 52, one or more antennas, one or more input/output devices, and control circuitry that includes one or more components similar to control circuitry 44. Unlike UE devices 10, gateway 14 is stationary and remains at a fixed location on Earth. Gateways 14 are not owned or operated by end users of UE devices 10. Gateway 14 may include one or more electronic devices. The electronic device(s) of a gateway 14 may be enclosed within a housing, enclosure, building, etc.

FIG. 3 is a diagram of an illustrative satellite 12 in communications system 38. As shown in FIG. 3, satellite 12 may include satellite support components 56. Support components 56 may include batteries, solar panels, sensors (e.g., accelerometers, gyroscopes, temperature sensors, light sensors, etc.), guidance systems, propulsion systems, and/or any other desired components associated with supporting satellite 12 in orbit above Earth.

Satellite 12 may include control circuitry 58. Control circuitry 58 may be used in controlling the operations of satellite 12. Control circuitry 58 may include processing circuitry such as processing circuitry 48 of FIG. 2 and may include storage circuitry such as storage circuitry 46 of FIG. 2. Control circuitry 58 may also control support components 56 to adjust the trajectory or position of satellite 12 in space.

Satellite 12 may include antennas 62 and one or more radios 60. Radios 60 may use antennas 62 to transmit DL signals 26 and DL signals 30 and to receive UL signals 24 and UL signals 28 of FIG. 1 (e.g., in one or more satellite communications bands). Radios 60 may include transceivers, modems, integrated circuit chips, application specific integrated circuits, filters, switches, up-converter circuitry, down-converter circuitry, analog-to-digital converter circuitry, digital-to-analog converter circuitry, amplifier circuitry (e.g., multiport amplifiers), beam steering circuitry, etc.

Antennas 62 may include any desired antenna structures (e.g., patch antenna structures, dipole antenna structures, monopole antenna structures, waveguide antenna structures, Yagi antenna structures, inverted-F antenna structures, cavity-backed antenna structures, combinations of these, etc.). In some implementations, antennas 62 may include one or more phased array antennas. Each phased array antenna may include beam forming circuitry having a phase and magnitude controller coupled to each antenna element in the phased array antenna. The phase and magnitude controllers may provide a desired phase and magnitude to the radio-frequency signals conveyed over the corresponding antenna element. The phases and magnitudes of each antenna element may be adjusted so that the radio-frequency signals conveyed by each of the antenna elements constructively and destructively interfere to produce a radio-frequency signal beam (e.g., a spot beam) in a desired pointing direction (e.g., an angular direction towards Earth at which the radio-frequency signal beam exhibits peak gain). Radio-frequency lenses may also be used to help guide the radio-frequency signal beam in a desired pointing direction. Each radio-frequency signal beam also exhibits a corresponding beam width. This allows each radio-frequency signal beam (e.g., signal beam 17 of FIG. 1) to cover a corresponding area on Earth (e.g., a region on Earth overlapping the radio-frequency signal beam such that the radio-frequency signal beam exhibits a power greater than a minimum threshold value within that region/cell). Satellite 12 may convey radio-frequency signals over multiple concurrently-active signal beams if desired. If desired, satellite 12 may offload some or all of its beam forming operations to gateway 14. The signal beams may sometimes be referred to herein simply as beams.

If desired, radios 60 and antennas 62 may support communications using multiple polarizations. For example, radios 60 and antennas 62 may transmit and receive radio-frequency signals with a first polarization (e.g., a left-hand circular polarization (LHCP)) and may transmit and receive radio-frequency signals with a second polarization (e.g., a right-hand circular polarization (RHCP)). Antennas 62 may be able to produce a set of different signal beams at different beam pointing angles (e.g., where each beam overlaps a respective cell on Earth). If desired, the set of signal beams may include a first subset of signal beams that convey LHCP signals (e.g., LHCP signal beams) and a second subset of signal beams that convey RHCP signals (e.g., RHCP signal beams). The LHCP and RHCP signal beams may, for example, be produced using respective multiport power amplifiers (MPAs) on satellite 12. This is illustrative and, in general, satellite 12 may produce any desired number of signal beams having any desired polarizations. A satellite 12 may, for example, transmit (forward) one or more broadcast messages and/or one or more forward link datagrams and/or may receive one or more reverse link datagrams using some or all of its signal beams during each system cycle of communications between UE devices 10 and CN 20. Different signal beams may, for example, be active during different respective subsets of each system cycle. In other implementations, multiple signal beams may be active during the same portion(s) of each system cycle. The example of FIG. 3 is illustrative and, in general, some or all of the components shown in FIG. 3 may be us

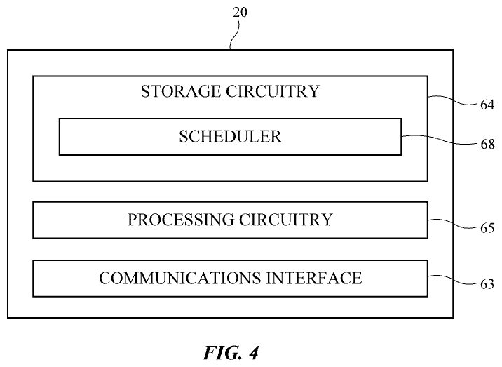

FIG. 4 is a schematic diagram of CN 20. The components of CN 20 may be implemented on one or more underlying physical devices in network portion 18 (FIG. 1). As shown in FIG. 4, CN 20 may include storage circuitry 64 (e.g., similar to storage circuitry 46 of FIG. 2) and processing circuitry 65 (e.g., similar to processing circuitry 48 of FIG. 2). CN 20 may also include one or more communications interfaces such as communications interface 63.

Storage circuitry 64 may store a communications scheduler such as scheduler 68 (e.g., a software-based scheduler that is executed using processing circuitry 65). Scheduler 68 may store communications schedules (e.g., forward link communications schedules) for each of the UE devices 10 that communicate with CN 20 (e.g., that communicate with CN 20 via constellation 32 of FIG. 1 while the UE devices are off grid and/or via terrestrial-based communications equipment 22 while the UE devices are on grid). Scheduler 68 may, for example, generate forward link traffic grants for the UE devices based on and/or implementing the stored communications schedules. Communications interface 63 may transmit forward link data (e.g., as received from another UE device, a CDN, or another data source, terminal, or end host in communications system 38) to UE devices 10 via constellation 32 and gateway(s) 14 (FIG. 1). Communications interface 63 may also receive reverse link data from UE devices 10 via constellation 32. Communications interface 63 may forward the reverse link data to a corresponding destination (e.g., another UE device, data destination, terminal, or end host in communications system 38). Communications interface 63 may include a wired communications interface (e.g., a cabled interface, an optical interface, etc.) and/or a wireless communications interface (e.g., wireless communications circuitry having one or more antennas).

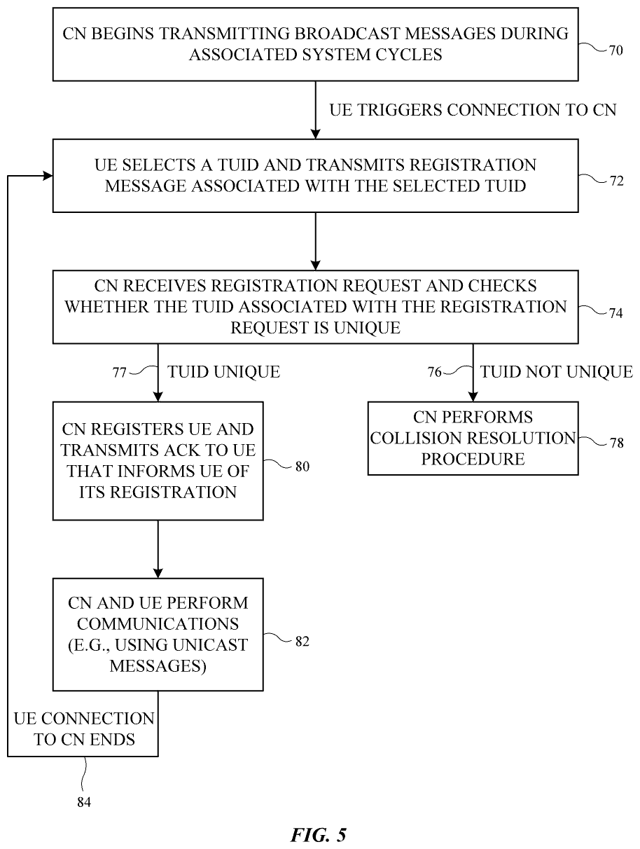

FIG. 5 is a flow chart of illustrative operations involved in performing wireless communications between UE device 10 (e.g., UE device 10-1 of FIG. 1) and CN 20 via a wireless network having a serving node, such as a satellite 12 of FIG. 1. The operations of FIG. 5 may, for example, be performed while UE device 10 is off-grid or at any other desired time.

At operation 70, CN 20 may begin transmitting broadcast messages within beam 17 (FIG. 1) via satellite 12 and gateway 14. CN 20 may continue to periodically transmit a respective broadcast message during each system cycle of communications system 38 (e.g., during a broadcast interval in the downlink cycle of the system cycle) while processing the remaining operations of FIG. 5. The broadcast message may be received and decoded by each UE device overlapping beam 17 (e.g., UE devices 10-1 and 10-2 of FIG. 1). Processing may proceed to operation 72 when UE device 10 triggers a connection to CN 20. This may occur, for example, when an application running on UE device 10 has wireless data to transmit to an associated destination via CN 20, when UE device 10 receives a user input identifying or triggering the transmission of wireless data, periodically, and/or in response to any other desired trigger condition to begin communications via CN 20 (e.g., while UE device 10 is off-grid). UE device 10 may then attempt to register (connect) to CN 20 for wireless communications service via a serving node (e.g., satellite 12).

At operation 72, UE device 10 may select (e.g., generate, compute, calculate, identify, create, produce, output, etc.) a temporary user identifier (TUID) for use in registering (connecting) to CN 20 for wireless communications. The temporary user identifier is a number represented by a series of binary bits that is used to uniquely identify UE device 10 for wireless services at CN 20. The TUID may, for example, include a series of 20 bits, 10-30 bits, 10-50 bits, or any other desired number of bits. Longer TUIDs may reduce the risk of the same TUID incidentally being generated by multiple different UE devices in signal beam 17 but also consume more resources to transmit via the bandwidth-limited satellite constellation. UE device 10 may also be identified by a permanent user identifier that is persistent across communications sessions (e.g., as configured by the network, upon manufacture, by software running on UE device 10, etc.).

Unlike a permanent user identifier, the temporary user identifier may be used to identify UE device 10 for just a single communications session (e.g., while the UE device remains registered/connected to the CN) and is discarded after that communications session has ended. Different TUIDs may be produced and used for subsequent communications sessions. A current communications session may automatically end (from the perspective of the UE device) after a predetermined time period has elapsed (e.g., 5-30 minutes, 5-15 minutes, 10-15 minutes, 10-20 minutes, 1-60 minutes, 10-60 minutes, 14 minutes, etc.) without successful reception of forward link data from CN 20 or successful reception of an acknowledgement (ACK) to reverse link data transmitted by UE device 10 during that communications session. The current communications session may also end in response to an application call by software running on device 10, in response to receipt of a user input instructing device 10 to disconnect from CN 20 and/or constellation 32, after an extended time period has elapsed even when forward link data and/or ACKs to reverse link data have been received at UE device 10 (e.g., 1-12 hours, 8 hours, 6-12 hours, more than 12 hours, etc.), and/or in response to any desired trigger condition.

UE device 10 may attempt to register (connect) to CN 20 by transmitting a registration message to CN 20 via satellite 12. The registration message may be associated with the selected TUID. The registration message may, for example, include the selected TUID or may include information (e.g., in one or more header fields of the registration message) that can be used by CN 20 to derive the selected TUID from the registration message.

At operation 74, CN 20 may receive the registration message transmitted by UE device 10 via satellite 12 and a corresponding gateway 14. CN 20 may identify the selected TUID from information in the registration message. CN 20 may store the identified TUID in storage for subsequent processing. CN 20 may compare the identified TUID to a list of TUIDs of UE devices that are already registered (connected) with CN 20 to determine whether the identified TUID is unique.

If/when the identified TUID matches a TUID of a UE device that is already registered with CN 20 (e.g., that is already connected to CN 20 in a corresponding communications session), CN 20 may determine that the TUID is not unique and processing may proceed to operation 78 via path 76. At operation 78 (e.g., responsive to the identified TUID not being unique), CN 20 may perform a collision resolution procedure to allow UE device 10 register with the network despite the identified TUID already being registered for communications by another UE device in signal beam 17.

In general, any desired collision resolution procedure may be used by CN 20 and UE device 10. As one example, CN 20 may create a TUID collision record associated with the identified TUID and may transmit one or more messages that instruct UE device 10 to create a new TUID and to attempt to re-register to CN 20 using the new TUID (e.g., during the next system cycle or a later system cycle than the system cycle during which the UE device transmitted its registration request at operation 72). If desired, the message(s) may include an offset for UE device 10 to apply to its new TUID to help ensure that the new TUID is different than any of the TUIDs already registered to CN 20. This example is illustrative and non-limiting.

On the other hand, if/when the identified TUID does not match any of the TUIDs for UE devices that are already registered with CN 20 (e.g., for the same signal beam 17 of the same satellite 12 of the same system cycle), CN 20 may determine that the TUID is unique and processing may proceed from operation 74 to operation 80 via path 77. At operation 80 (e.g., responsive to the identified TUID being unique), CN 20 may register UE device 10 for connected mode communications. CN 20 may transmit a registration ACK to the UE device that informs the UE device that it is now registered with CN 20. The registration ACK may, for example, identify or include the TUID selected by UE device 10 at operation 72. UE device 10 may receive the registration ACK (e.g., during the next broadcast interval) and may assume that it is registered with CN 20 in response to decoding its selected TUID in the registration ACK.

At operation 82, CN 20 and UE device 10 may perform wireless communications (e.g., in a connected or registered mode) via satellite 12 (e.g., during subsequent system cycles). This may involve the transmission of forward link unicast messages addressed to UE device 10 and/or the transmission of reverse link messages to CN 20. When the communications session ends (e.g., when the wireless connection between UE device 10 and CN 20 and/or the registration of UE device 10 to CN 20 ends), processing may loop back to operation 72 via path 84.

In situations where there are many UE devices that attempt to register with CN 20 at the same time (e.g., during the same system cycle) within the same signal beam 17 of satellite 12, there is a small but non-zero probability that two of the UE devices (e.g., UE devices 10-1 and 10-2 of FIG. 1) will select the same TUID, creating a registration conflict/collision between the UE devices (e.g., because each UE device is unaware of the other UE devices attempting to register to CN 20). In these situations (assuming the TUID is not also shared by another UE device already registered to CN 20), CN 20 may transmit a registration ACK (e.g., at operation 80) identifying the TUID to all of the UE devices in signal beam 17. When UE devices 10-1 and 10-2 receive the registration ACK, each UE device will independently assume that it is registered with CN 20 due to the presence of its selected TUID in the registration ACK. During subsequent communications (e.g., at operation 82), UE device 10-1 may erroneously assume that ACKs transmitted by CN 20 in response to reverse link transmissions by UE device 10-2 are actually acknowledging receipt of its own reverse link transmissions and vice versa (e.g., one UE device may misinterpret its network status as registered even though the other UE device is actually registered to CN 20). This can increase message transmission/reception failure, data error rates, and/or latency for one or both UE devices, deteriorating user experience. The UE device that mistakenly believes that it is registered to CN 20 is sometimes referred to herein as an incognito UE or an incognito registered UE. If desired, a collision resolution procedure (see, e.g., operation 78) may be performed to cause both UE devices to re-attempt registration with CN 20 with potentially different TUIDs. If, for example, the registration request of only a first of UE devices 10-1 and 10-2 is received at CN 20, the registration request for the second of UE devices 10-1 and 10-2 was not detected or failed to decode at the CN. As such, once CN 20 transmits an acknowledgment for the first UE device and the second UE device may mistakenly believe the acknowledgment was intended for the second UE device. Another possibility is that both UE devices transmit a registration request in the same cycle using the same TUID. Due to different processing or network latencies, the registration request for a first of the UE devices may be processed during cycle N and the CN may generate a corresponding acknowledgement for that registration request. However, processing for the registration request of the second of the UE devices may be pushed to the next cycle (e.g., cycle N+1). Even if the CN is aware of the collision and might attempt to issue a collision resolution, the second of the UE devices may already believe it has registered based on the acknowledgement issued for the registration request from the first UE device and may ignore subsequent collision resolution performed by the CN, believing erroneously that it is addressed to another UE that chose the same TUID. If desired, the CN may transmit a flash TUID message to help resolve these issues as outlined below.

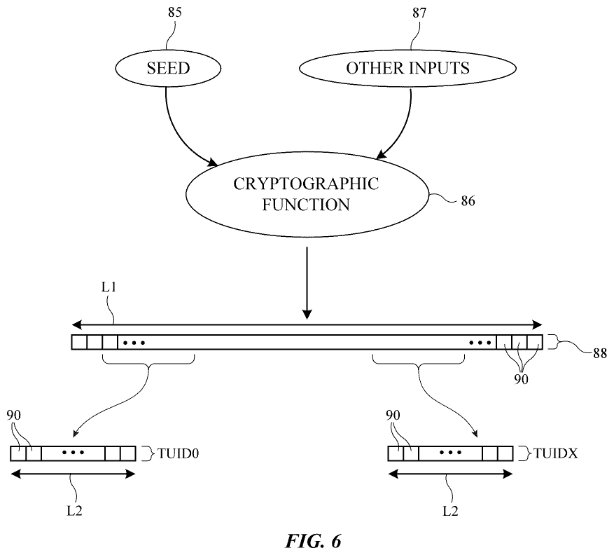

Additionally, or alternatively, in implementations that are described herein as an example, UE device 10 may mitigate these issues by utilizing two different TUIDs for communicating with CN 20 in a given communications session. The two different TUIDS may include, for example, a first TUID for use during registration and a second TUID that is different from the first TUID for use during subsequent communications after registration. FIG. 6 is a diagram showing one example of how UE device 10 may generate two different TUIDs for use in communicating with CN 20.

As shown in FIG. 6, UE device 10 may include hardware (e.g., one or more processors, digital logic gates, etc.) and/or software (e.g., one or more software functions executed by one or more processors) that implement a corresponding cryptographic function 86 (e.g., a hashing function). UE device 10 may provide a cryptographic seed value such as seed 85 and one or more other inputs 87 to cryptographic function 86. Other inputs 87 may include time information, identifier information, information from a broadcast message received by UE device 10 (e.g., during a most recent or current broadcast interval), and/or any other desired information. Cryptographic function 86 may generate/output a cryptographic value 88 based on seed 85 and other inputs 87 (e.g., by hashing seed 85 with other inputs 87). Value 88 may be represented by a series of consecutive bits 90. Value 88 may have a relatively long length (size) such as bitlength L1. Bitlength L1 may be, for example, as large as 50-60 bytes, 40-80 bytes, 30-70 bytes, greater than 80 bytes, etc. The entirety of value 88 may be too long to use as the TUID for UE device 10, particularly given the bandwidth constraints of constellation 32.

As such, UE device 10 may select a subset of the bits 90 in value 88 to serve as a corresponding TUID for UE device 10. For example, as shown in FIG. 6, UE device 10 may select a first series of bits 90 from value 88 to serve as a first TUID such as TUID0 and may select a second series of bits 90 from value 88 to serve as a second TUID such as TUIDX. UE device 10 may store information identifying which bits 90 or which bit positions of value 88 are selected to serve as TUID0 and TUIDX respectively. Each TUID has a corresponding bitlength L2 that is significantly smaller than bitlength L1. Bitlength L2 may be, for example, 20 bits (e.g., TUID0 and TUIDX may each contain 20 respective bits 90 from value 88).

In the example of FIG. 6, TUID0 and TUIDX are each formed from a respective set of consecutive bits 90 in value 88. As one example, TUID0 may be formed from the twenty bits 90 in bit positions 0-19 of value 88 whereas TUIDX is formed from the twenty bits 90 in bit positions 20-39 of value 88. This is illustrative and non-limiting. TUID0 and TUIDX may be formed from the bits 90 of any desired bit positions in value 88. If desired, one or both TUIDs may be formed from non-consecutive bits of value 88. The bit positions of value 88 used to form TUID0 may be completely different than the bit positions of value 88 used to form TUIDX or, if desired, one or more bit positions of value 88 may be included in both TUID0 and TUIDX (e.g., TUID0 and TUIDX may be formed from non-overlapping portions/segments of value 88 or may be formed from partially overlapping and partially non-overlapping portions/segments of value 88). Bitlength L2 may be other sizes if desired (e.g., 10-30 bits, 10 bits, 30 bits, 10-50 bits, 5-60 bits, etc.). In general, longer bitlengths L2 minimize the risk that two different UE devices will produce the same TUID but consume more resources when the TUIDs are transmitted via satellite 12. A shared communications and/or cryptographic protocol implemented by both UE device 10 and CN 20 may cause UE device 10 and CN 20 to both have knowledge of cryptographic function 86 and how to produce TUID0 and TUIDX from a corresponding seed 85 and other inputs 87. UE device 10 may use both TUID0 and TUIDX to perform communications with CN 20 in a manner that mitigates potential registration collision with another UE device in the same signal beam 17 of the same satellite 12 during a given communications session.

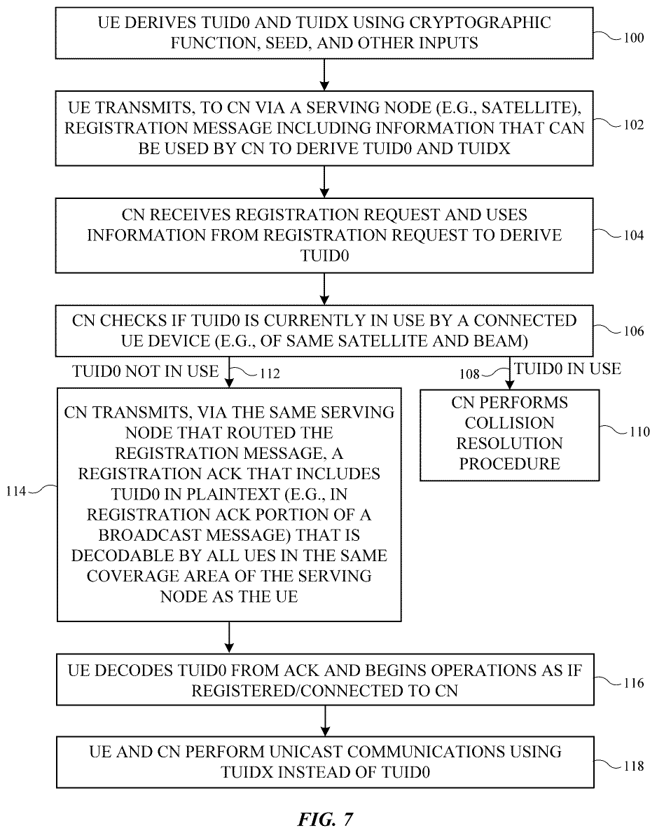

FIG. 7 is a flow chart of illustrative operations involved in performing wireless communications between UE device 10 (e.g., UE device 10-1) and CN 20 using both TUID0 and TUIDX of FIG. 6 (e.g., in a manner that mitigates potential registration conflicts with other UE devices such as UE device 10-2). Operations 100-102 of FIG. 7 may be performed while processing operation 72 of FIG. 5, operations 104-106 of FIG. 7 may be performed while processing operation 74 of FIG. 5, operation 110 of FIG. 7 may be performed while processing operation 78 of FIG. 5, operations 114-116 may be performed while processing operation 80 of FIG. 5, and operation 118 of FIG. 7 may be performed while processing operation 82 of FIG. 5, for example.

At operation 100, UE device 10 may generate (e.g., calculate, compute, produce, derive, select, identify, etc.) a first TUID such as TUID0 and a second TUID such as TUIDX for use in communicating with CN 20 during an upcoming communications session. For example, UE device 10 may input seed 85 and other inputs 87 (FIG. 6) to cryptographic function 86, which outputs value 88. UE device 10 may then select a first set of bits 90 from a first set of bit positions in value 88 to serve as TUID0 and may select a second set of bits 90 from a second set of bit positions in value 88 to serve as TUIDX. UE device 10 may, if desired, store information identifying the bit positions used to form each TUID or, if desired, the bit positions to be used may be specified by the communications/cryptographic protocol governing communications between UE device 10 and CN 20.

TUID0 may serve as a registration TUID that is used by UE device 10 to register to CN 20. TUID0 is sometimes also referred to herein as registration temporary user identifier TUID0, registration user identifier TUID0, or primary temporary user identifier TUID0. TUIDX may serve as a supplemental TUID that is used to perform communications with CN 20 during the corresponding communications session after UE device 10 has already registered with CN 20 (e.g., for use during unicast transmissions, reverse link transmissions, and/or acknowledgment transmissions). TUIDX is sometimes also referred to herein as connected temporary user identifier TUIDX, connected user identifier TUIDX, supplemental user identifier TUIDX, or registered user identifier TUIDX.

At operation 102, UE device 10 may transmit a registration message (sometimes also referred to herein as a registration request) to CN 20 via satellite 12 (or another type of serving node in non-satellite-based implementations of communications system 38). The registration message may include information that can be used by CN 20 to recover the TUID0 and the TUIDX generated by UE device 10 at operation 100. For example, the registration message may include seed 85 (FIG. 6), some or all of other inputs 87, and/or information identifying the bit positions of value 88 to use as TUID0 and TUIDX (e.g., in a header field or another field of the registration message). Alternatively, the registration message may include TUID0 and TUIDX or may include any other information that identifies TUID0 and TUIDX.

At operation 104, CN 20 may receive the registration message transmitted by UE device 10 via satellite 12 (or another type of serving node in non-satellite-based implementations of communications system 38). CN 20 may identify TUID0 and/or TUIDX from information in the registration request. For example, CN 20 may input seed 85 and other inputs 87 (e.g., as identified by the registration message, other information stored at CN 20, and/or the corresponding protocol) to cryptographic function 86 and may derive (e.g., define, generate, calculate, compute, output, identify, recover, etc.) TUID0 and TUIDX as the bits 90 from the corresponding bit positions of value 88 that were used by UE device 10 to generate TUID0 and TUIDX, respectively (e.g., bit positions as identified by information in the registration message itself, other information stored at CN 20, and/or the corresponding protocol).

At operation 106, CN 20 may compare TUID0 to a list of TUIDs that are currently being used by other UE devices that are registered to communicate with CN 20 (e.g., via the same satellite and signal beam for the current system cycle). If/when TUID0 is already registered with CN 20 (e.g., when TUID0 is not unique and is already in use), processing may proceed to operation 110 via path 108. At operation 110, CN 20 may perform the collision resolution procedure (see, e.g., operation 78 of FIG. 5) to avoid conflicting use of TUID0 for registration.

If/when TUID0 is not already registered with CN 20 (e.g., when TUID0 is unique and is not already in use), processing may proceed from operation 106 to operation 114 via path 112. At operation 114, CN 20 may transmit a registration ACK message in the forward link direction via the same satellite 12 and signal beam 17 that were used to route the registration message from UE device 10 to CN 20. The registration ACK message (sometimes also referred to herein simply as a registration ACK) may include TUID0 in an unencrypted format that is decodable by all of the UE devices in that signal beam (e.g., as plaintext that is readable or decodable by both UE devices 10-1 and 10-2 of FIG. 1). As one example, CN 20 may transmit the registration ACK, including TUID0, in a broadcast message that is broadcast by satellite 12 within signal beam 17. The registration ACK and TUID0 may, for example, be included in a registration ACK portion of the broadcast message (e.g., in one or more registration ACK fields of the broadcast message as defined by the protocol governing communications between UE device 10 and CN 20).

At operation 116, all of the UE devices in signal beam 17 of satellite 12 may receive the registration ACK transmitted by CN 20 (e.g., in a broadcast message of a corresponding broadcast interval). UE devices that attempted to register to CN 20 in the corresponding system cycle may search the registration ACK field of the broadcast message to search for their corresponding registration TUID as acknowledgment and confirmation that the UE device has been registered with CN 20. UE device 10 may, for example, decode the registration ACK field and may search the registration ACK field for TUID0. Upon successfully identifying (e.g., decoding) TUID0 in the registration ACK, UE device 10 assumes that it is registered with CN 20 and may begin communications as if registered/connected to the CN.

At operation 118, UE device 10 and CN 20 may perform subsequent communications during the current communications session (e.g., using the current registration of UE device 10 to CN 20 based on TUID0) but using the TUIDX of UE device 10 instead of TUID0 (e.g., TUIDX may serve as a transmission TUID or unicast TUID rather than as a registration TUID). This may include UE device 10 transmitting reverse link messages that include or identify TUIDX (instead of TUID0) and/or may include CN 20 transmitting unicast forward link messages to UE device 10 that include or identify TUIDX (instead of TUID0). Reverse link and forward link transmissions may also involve ACK transmissions that include or identify TUIDX. Unlike broadcast messages, unicast messages are transmitted during a unicast portion of each system cycle and are addressed to UE device 10 in particular rather than a broadcast address (e.g., have a destination address field using an address of UE device 10 rather than a broadcast address or indicator). Use of TUIDX instead of TUID0 for communications after registration has been completed using TUID0 may help to mitigate one UE device mistakenly believing that it is registered to CN 20 and that ACKs intended for another UE device are actually intended for that UE device. Put differently, colliding registration TUIDs from multiple UE devices do not affect ongoing unicast TUIDs used by the UE devices. By decoupling registration and transmission TUID spaces, registration collisions may be isolated from impacting ongoing communications. If desired, CN 20 may also perform a flash TUID procedure to help incognito UEs to perform a satisfactory and unique registration to the CN.

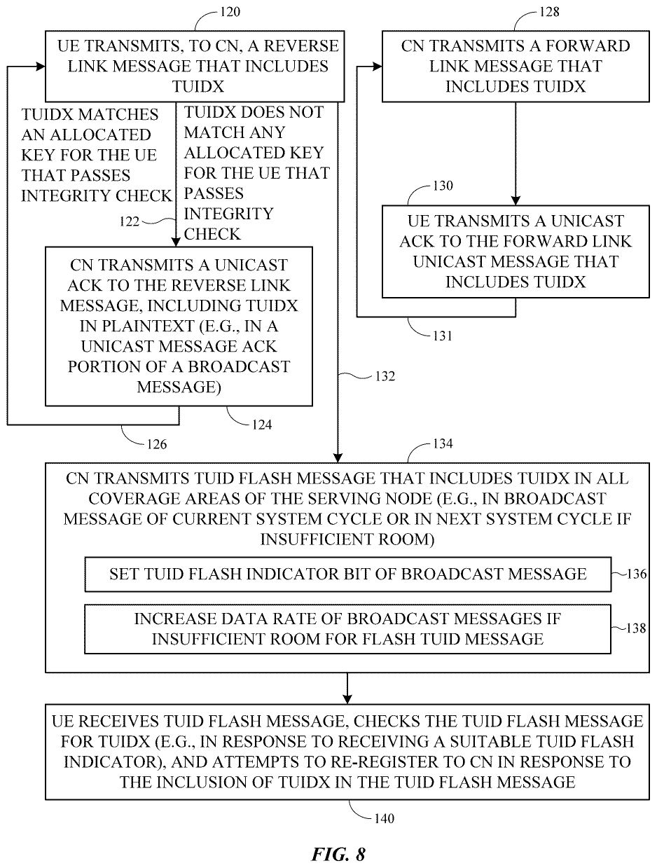

FIG. 8 is a flow chart of operations that may be performed by CN 20 and UE device 10 to perform communications/transmissions after UE device 10 has registered to CN 20 using its TUID0. The operations of FIG. 8 may, for example, be performed while processing operation 118 of FIG. 7. Operations 120-124 of FIG. 8 are associated with reverse link transmissions from UE device 10 to CN 20 via satellite 12 (or a different type of serving node). Operations 128-130 are associated with forward link transmissions from CN 20 to UE device 10 via satellite 12 (or a different type of serving node). Operations 120-124 may be omitted when only forward link communications are performed during the current session. Operations 128-130 may be omitted when only reverse link communications are performed during the current session. Operations 120-124 may be interleaved with operations 128-130 and/or some or all of operations 120-124 may be performed concurrent with some or all of operations 120-124 (e.g., a reverse link transmission and/or a forward link transmission may be performed during any given system cycle of the current session, and some system cycles of the current session may include no unicast transmissions to/from UE device 10).

At operation 128, CN 20 may transmit a forward link message to UE device 10 via satellite 12 (e.g., a unicast forward link message addressed to UE device 10). The forward link message may include or otherwise identify the TUIDX of UE device 10 (e.g., CN 20 may generate TUIDX at operation 104 of FIG. 7 or using the same procedure as operation 104 of FIG. 7). TUIDX may, for example, be included in a header field of the forward link message (e.g., as plaintext in a TUID header field of the forward link message).

At operation 130, UE device 10 may receive the forward link message containing its TUIDX from CN 20. In response to successfully receiving/decoding the forward link message containing TUIDX, UE device 10 may transmit an ACK message (e.g., a unicast ACK) to CN 20 via satellite 12. CN 20 may use receipt of the ACK message to confirm that UE device 10 has received its forward link message before transmitting its next forward link message for UE device 10. If desired, CN 20 may attempt to re-transmit a forward link message if it does not receive a corresponding ACK message within a predetermined time period and/or number of system cycles. Processing may loop back to operation 128 via path 131 as additional forward link messages are transmitted during subsequent system cycles.

At operation 120, UE device 10 may transmit a reverse link message to CN 20 via satellite 12. UE device 10 may include or otherwise identify the TUIDX of UE device 10 (e.g., as generated by UE device 10 at operation 100 of FIG. 7) in the reverse link message. UE device 10 may, for example, include TUIDX in a header field of the reverse link message (e.g., in a TUID header field of the reverse link message). CN 20 may receive the reverse link message via satellite 12. CN 20 may identify the TUIDX included in the reverse link message. CN 20 may determine whether the identified TUIDX matches an allocated key for UE device 10 that passes a message integrity check (e.g., TUIDX may perform a message integrity check on the received reverse link message that passes when TUIDX matches an allocated key for the UE device and that fails when the TUIDX does not match an allocated key for the UE device).

If/when TUIDX does not match any allocated key for UE device 10 that passes the message integrity check (e.g., when the CN has no knowledge of any UE devices authenticated and registered with TUIDX, the received reverse link message may fail a message integrity check performed by the CN), this may be indicative of UE device 10 being an incognito UE device that incorrectly believes that it is registered to CN 20 (e.g., when another UE device from the same signal beam and satellite used the same TUID0 to register with the CN). In these situations, processing may proceed to operation 134 via path 132 and the CN may use a flash TUID message to help the incognito UE device recover a registration with the CN. On the other hand, if/when TUIDX matches an allocated key for UE device 10 that passes the message integrity check (e.g., when the received reverse link message passes a message integrity check performed by the CN), processing may proceed to operation 124 via path 122.

At operation 124, CN 20 may transmit a unicast ACK to the reverse link message received from UE device 10. CN 20 may include TUIDX in a decodable/unencrypted format in the unicast ACK. CN 20 may, for example, include the TUIDX in plaintext in the unicast ACK. CN 20 may, for example, include the unicast ACK and TUIDX in a unicast ACK portion (e.g., a unicast ACK field) of a broadcast message that is broadcast over signal beam 17 of satellite 12 (e.g., during a corresponding broadcast interval after transmission of the reverse link message at operation 120). Processing may loop back to operation 120 via path 126 as additional reverse link messages are transmitted during subsequent system cycles.

At operation 134 (e.g., responsive to CN 20 receiving a reverse link message from UE device 10 that fails message integrity check and/or that does not match any allocated key stored at CN 20), CN 20 may generate and transmit a TUID flash message that includes or otherwise identifies TUIDX. CN 20 may transmit the TUID flash message on all of the coverage areas (e.g., all signal beams 17) of the satellite 12 that is serving UE device 10 (e.g., during the same system cycle). This may help to ensure that UE device 10 receives the TUID flash message even when UE device 10 is located at the boundary of a signal beam 17 or when UE device 10 has moved from one signal beam to another signal beam of satellite 12 (e.g., because the CN has knowledge that there is an incognito UE device being served by satellite 12 when the message integrity check on a received reverse link message fails but does not otherwise have knowledge of where the incognito UE device is located). UE device 10 may, for example, transmit the TUID flash message within a broadcast message of the current system cycle or, if/when there is insufficient space in the broadcast interval of the current system cycle, may transmit the TUID flash message in the broadcast message of the next system cycle. UE device 10 may, for example, transmit the TUID flash message in a trailing field of the broadcast message. If desired, the TUID flash message may include TUIDX in plaintext (e.g., unencrypted).

If desired, CN 20 may set a TUID flash indicator bit of the broadcast message (e.g., in a header field of the broadcast message) to signal or identify that the broadcast message includes a TUID flash message (at operation 136). This may serve to identify, to all UE devices served by satellite 12, that the broadcast message contains a TUID flash message. The TUID flash indicator may have a first value (e.g., binary “1”) when the broadcast message includes a TUID flash message and may have a second value (e.g., binary “0”) when the broadcast message does not include any TUID flash messages. If desired, CN 20 may increase the data rate of broadcast messages (e.g., decreasing the period of the broadcast interval) if/when there is insufficient room in a single broadcast message to fit the TUID flash message (at operation 138).

At operation 140, UE device 10 may receive the TUID flash message (e.g., within one or more broadcast messages transmitted by CN 20). UE device 10 may search the TUID flash message (e.g., the broadcast message) for its TUIDX (e.g., in response to the TUID flash indicator having the first value). UE device 10 may search for the TUID flash message by, for example, successfully decoding TUIDX from the TUID flash message, by obtaining a suitable output from convolving the TUID flash message with TUIDX, and/or using any desired techniques. UE device 10 may forego searching for TUIDX in the TUID flash message if/when the TUID flash indicator has the second value, if desired.

If/when the TUID flash message does not include the TUIDX of UE device 10 (e.g., when the TUID flash message includes a TUID for a different UE device), UE device 10 may ignore the TUID flash message (e.g., because the TUID flash message is intended to inform a different UE device that it mistakenly believes it is registered to CN 20). If/when the TUID flash message does include the TUIDX of UE device 10, UE device 10 may determine or identify that it is an incognito UE device that mistakenly believes it is registered to CN 20 even though a different UE device is registered to CN 20 using the same TUID0. In response to the TUID flash message including TUIDX, UE device 10 may then attempt to re-register with CN 20 (e.g., processing may revert to operation 100 of FIG. 7). Use of the TUID flash message may allow the UE device to successfully register with CN 20 and begin wireless communications much faster than waiting for what it erroneously believes is its own registered communications session to time out after a predetermined time period without successfully performing communications with CN 20 has elapsed (e.g., after 14 minutes). This may greatly reduce the impact of registration collision on wireless communications by UE device 10 and the corresponding detriment to user experience.

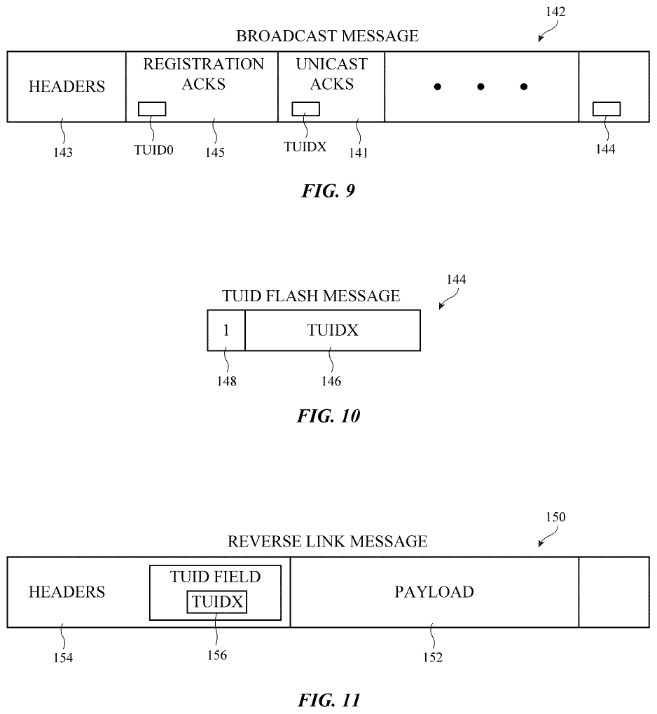

FIG. 9 is a diagram of an illustrative broadcast message 142 that may be transmitted by CN 20 (e.g., that satellite 12 may broadcast over its signal beam 17 during the broadcast interval of each system cycle). As shown in FIG. 9, broadcast message 142 may include one or more headers 143 (e.g., header fields). Broadcast message 142 may include a registration ACK portion such as one or more registration ACK fields 145. Registration ACK field 145 may include any registration ACKs to registration messages received from UE devices (e.g., at operation 104 of FIG. 7) during the current or previous system cycle. For example, when CN 20 transmits broadcast message 142 in response to a registration request from UE device 10 that includes TUID0 (e.g., at operation 114 of FIG. 7), CN 20 may include a registration ACK to that registration message in registration ACK field 145. The registration ACK may include the TUID0 of UE device 10 (e.g., as plaintext) in registration ACK field 145.

Broadcast message 142 may also include a unicast ACK portion such as one or more unicast ACK fields 141. Unicast ACK field 141 may include any unicast ACKs to reverse link messages received from UE devices during the current or previous system cycle. For example, when CN 20 transmits broadcast message 142 in response to a reverse link message received from UE device 10 that includes TUIDX (e.g., at operation 120 of FIG. 8), CN 20 may include a unicast ACK to that reverse link message in unicast ACK field 141. The unicast ACK may be associated with a destination address of UE device 10. The unicast ACK may include the TUIDX of UE device 10 (e.g., as plaintext) in unicast ACK field 141. Unicast ACK field 141 and broadcast ACK field 145 may be header fields (e.g., may be included as a part of header(s) 143) or may be separate from the header fields (e.g., may be between headers 143 and a payload of broadcast message 142).

In situations where broadcast message 142 includes a TUID flash message (e.g., at operation 134 of FIG. 8), broadcast message 142 may include a TUID flash message 144 in one or more fields such as a trailing field of broadcast message 142 (e.g., a trailing field after a payload of the broadcast message and before final trailing fields such as integrity check fields, CRC fields, etc.). In this way, CN 20 may insert TUID flash message 144 into an unused (unoccupied) portion of the broadcast interval when there is sufficient space to fit the TUID flash message. If there is insufficient space, CN 20 may delay transmission of the TUID flash until a later broadcast interval and/or may increase its broadcast data rate. Alternatively, CN 20 may transmit the TUID flash message as a dedicated flash message (e.g., having a broadcast destination address) that is separate from broadcast message 142.

FIG. 10 is a diagram of TUID flash message 144. As shown in FIG. 10, TUID flash message 144 may include a TUID field 146 that identifies the TUIDX that triggered CN 20 to transmit the TUID flash message (e.g., as plaintext). If desired, TUID flash message 144 may also include a TUID flash indicator bit 148 that precedes TUID field 146. TUID flash indicator bit 148 may be appended to a beginning of TUID field 146 and/or may be included in a header 143 of broadcast message 143 (e.g., may be included in a TUID flash indicator bit field of headers 143 and may, if desired, be separated from TUID field 146 of TUID flash message 144 by one or more other fields of broadcast message 142). TUID flash indicator 148 may be set to a first value (e.g., binary “1” as shown in FIG. 10) if/when TUID flash message 144 is included in broadcast message 142 and/or if/when a TUID (e.g., TUIDX) is included in TUID field 146. TUID flash indicator 148 may be set to a second value (e.g., binary “0”) if/when broadcast message 142 does not include any TUID flash messages and/or if/when TUID field 146 is empty. TUID flash indicator 148 may serve to trigger receiving UE devices to search broadcast message for its registered TUID (e.g., TUIDX) to trigger the UE device to re-register with the network.

FIG. 11 is a diagram of an illustrative reverse link message 150 that UE device 10 may transmit to CN 20 (e.g., at operation 120 of FIG. 8). As shown in FIG. 11, reverse link message 150 may include a data payload 152 preceded by one or more headers 154. Headers 154 may include a TUID field 156. TUID field 156 may include the TUIDX of UE device 10 (e.g., in plaintext). This may trigger CN 20 to transmit a unicast ACK in response to successfully receiving reverse link message 150 (e.g., in response to passing the message integrity check on reverse link message 150) that includes TUIDX (e.g., at operation 124 of FIG. 8). In practice, the format/structure of broadcast message 142, TUID flash message 144, and reverse link message 150 may be specified by the communication protocol used by CN 20 and UE device 10. The examples of FIGS. 9-11 are illustrative and, in general, broadcast message 142, TUID flash message 144, and reverse link message 150 may have other formats.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.” As used herein, the term “message” (e.g., a reverse link message, forward link message, etc.) may include some or all of one or more data packets, frames, or datagrams.

One or more elements described herein (e.g., UE devices 10, satellite 12, gateway 14, CN 20, etc.) may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The methods and operations described above in connection with FIGS. 1-10 may be performed using software, firmware, and/or hardware (e.g., dedicated circuitry or hardware). Software code for performing these operations may be stored on non-transitory computer readable storage media (e.g., tangible computer readable storage media) stored on one or more of the components of communications system 38 (e.g., storage circuitry 46 of FIG. 2 or similar storage circuitry on satellites 12, gateways 14, CN 20, network portion 18, etc.). The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of communications system 38 (e.g., processing circuitry 48 of FIG. 2 or similar processing circuitry on satellites 12, gateways 14, CN 20, network portion 18, etc.). The processing circuitry may include microprocessors, central processing units (CPUs), application-specific integrated circuits with processing circuitry, or other processing circuitry.

For one or more aspects, at least one of the components set forth in one or more of the preceding figures may be configured to perform one or more operations, techniques, processes, or methods as set forth herein. For example, the control circuitry as described above in connection with one or more of the preceding figures may be configured to operate in accordance with one or more of the examples set forth herein. For another example, circuitry associated with a UE, satellite, gateway, core network, base station, network element, etc. as described above in connection with one or more of the preceding figures may be configured to operate in accordance with one or more of the examples set forth herein.

An apparatus (e.g., an electronic user equipment device, a wireless base station, etc.) may be provided that includes means to perform one or more elements of a method described in or related to any of the methods or processes described herein.

One or more non-transitory computer-readable media comprising instructions to cause an electronic device, upon execution of the instructions by one or more processors of the electronic device, to perform one or more elements of any method or process described herein.

An apparatus comprising logic, modules, or circuitry to perform one or more elements of a method described in or related to any of the method or process described herein.

An apparatus comprising: one or more processors and one or more non-transitory computer-readable storage media comprising instructions that, when executed by the one or more processors, cause the one or more processors to perform the method, techniques, or process as described herein.

A signal, datagram, information element, packet, frame, segment, PDU, or message or datagram may be provided as described in or related to any of the examples described herein.

A signal encoded with data, a datagram, IE, packet, frame, segment, PDU, or message may be provided as described in or related to any of the examples described herein.

An electromagnetic signal may be provided carrying computer-readable instructions, wherein execution of the computer-readable instructions by one or more processors is to cause the one or more processors to perform the method, techniques, or process as described in or related to any of the examples described herein.

A computer program comprising instructions, wherein execution of the program by a processing element is to cause the processing element to carry out the method, techniques, or process as described in or related to any of the examples described herein.

A signal in a wireless network as shown and described herein may be provided.

A method of communicating in a wireless network as shown and described herein may be provided.

A system for providing wireless communication as shown and described herein may be provided.

A device for providing wireless communication as shown and described herein may be provided.

Any of the above-described examples may be combined with any other example (or combination of examples), unless explicitly stated otherwise. The foregoing description of one or more implementations provides illustration and description but is not intended to be exhaustive or to limit the scope of aspects to the precise form disclosed.

The foregoing is merely illustrative and various modifications can be made to the described embodiments. The foregoing embodiments may be implemented individually or in any combination.

What is claimed is:

1. A method of operating a user equipment (UE) device to communicate with a core network via a constellation of satellites, the method comprising:
transmitting, to the core network via a satellite in the constellation, a registration message that includes information usable by the core network to identify a first temporary user identifier (TUID) associated with the UE device;
receiving, from the core network via the satellite, a registration acknowledgment (ACK) that includes the first TUID; and
conveying, during a communications session associated with the registration message, wireless data with the core network based on a second TUID that is different than the first TUID.

2. The method of claim 1, wherein conveying the wireless data comprises:
transmitting a reverse link message to the UE device via the satellite.

3. The method of claim 2, wherein the reverse link message comprises a header, the header comprises a TUID field, and the TUID field comprises the second TUID.

4. The method of claim 3, wherein conveying the wireless data further comprises:
receiving, from the core network via the satellite, a unicast ACK to the reverse link message, wherein the unicast ACK comprises the second TUID.

5. The method of claim 4, wherein conveying the wireless data further comprises:
receiving, from the core network via the satellite during the communications session, a broadcast message, wherein the broadcast message comprises a unicast ACK field, the unicast ACK field comprises the unicast ACK, and the unicast ACK comprises the second TUID in plaintext.

6. The method of claim 1, further comprising:
receiving a broadcast message from the core network via the satellite, wherein the broadcast message comprises a registration ACK field, the registration ACK field comprises the registration ACK, and the registration ACK comprises the first TUID in plaintext.

7. The method of claim 1, wherein conveying the wireless data comprises:
receiving a unicast forward link message from the core network via the satellite.

8. The method of claim 7, wherein conveying the wireless data further comprises:
transmitting a unicast ACK to the core network via the satellite in response to receiving the unicast forward link message, wherein the unicast ACK comprises the second TUID.

9. The method of claim 1, further comprising:
generating, using one or more processors, a series of bits by inputting a plurality of inputs to a cryptographic hashing function;
generating, using the one or more processors, the first TUID as bits from a first set of bit positions in the series of bits; and
generating, using the one or more processors, the second TUID as bits from a second set of bit positions in the series of bits, the second set of bit positions being different than the first set of bit positions.

10. The method of claim 9, wherein the information usable by the core network to identify the first TUID comprises information identifying: the first set of bit positions, the second set of bit positions, or at least one input from the plurality of inputs.

11. The method of claim 1, further comprising:
receiving, from the core network via the satellite, a broadcast message that includes a TUID flash indicator bit;
searching, in response to the flash indicator bit having a predetermined value, the broadcast message for the second TUID; and
transmitting, to the core network responsive to the broadcast message including the second TUID, an additional registration request that includes a third TUID that is different from the first TUID and the second TUID.

12. A method of operating a core network to communicate via a constellation of satellites, the method comprising:
receiving, from a user equipment (UE) device via a satellite in the constellation, a registration request;
generating, using one or more processors, a first temporary user identifier (TUID) based on information in the registration request;
transmitting, via the satellite, a registration acknowledgment (ACK) that includes the first TUID; and
conveying, during a communications session associated with the registration message, wireless data with the UE device using a second TUID that is different than the first TUID.

13. The method of claim 12, wherein conveying the wireless data comprises:
receiving a reverse link message from the UE device via the satellite, wherein the reverse link message comprises a header field that includes the second TUID.

14. The method of claim 13, wherein conveying the wireless data further comprises:
transmitting, to the UE device via the satellite, a broadcast message, wherein the broadcast message comprises a unicast ACK field and the unicast ACK field comprises the second TUID.

15. The method of claim 14, wherein conveying the wireless data further comprises:
transmitting a forward link message to the UE device via the satellite, wherein the forward link message comprises the second TUID; and
receiving a unicast ACK from the UE device via the satellite, wherein the unicast ACK comprises the second TUID.

16. The method of claim 12, wherein conveying the wireless data comprises:
transmitting a forward link message via the satellite, wherein the forward link message comprises the second TUID.

17. The method of claim 16, wherein conveying the wireless data further comprises:
receiving a unicast ACK from the UE device via the satellite, wherein the unicast ACK comprises the second TUID.

18. The method of claim 12, wherein generating the first TUID comprises:
inputting at least the information in the registration request to a cryptographic function to produce a cryptographic value; and
selecting, as the first TUID, a series of 20 bits from the cryptographic value.

19. A method of operating a core network to communicate via a constellation of satellites, the method comprising:
receiving, from a user equipment (UE) device via a signal beam in a plurality of signal beams formed by a satellite in the constellation, a reverse link message that includes information associated with a temporary user identifier (TUID) of the UE device;
performing, using one or more processors, an integrity check on the reverse link message; and
transmitting, responsive to a failure of the integrity check, a flash message over the plurality of signal beams formed by the satellite during a system cycle of the satellite, wherein the flash message comprises the TUID.

20. The method of claim 19, wherein the flash message is included in a broadcast message transmitted over the plurality of signal beams during respective broadcast intervals of the system cycle, the broadcast message comprising a flash message indicator bit that identifies that the broadcast message includes the flash message.
